(19) United States
(12) Patent Application Publication
(10) Pub. No.: US 2019/0163337 A1
(43) Pub. Date: May 30, 2019

(54) System for Augmenting a Computer Display via a Mobile Device Display

(71) Applicant: Michael Ramirez Gill, Lorton, VA (US)

(72) Inventor: Michael Ramirez Gill, Lorton, VA (US)

(21) Appl. No.: 16/198,494

(22) Filed: Nov. 21, 2018

Related U.S. Application Data
(60) Provisional application No. 62/589,008, filed on Nov. 21, 2017.

(51) Int. Cl. G06F 3/0484; G06F 3/0488; G06F 3/0481

(52) U.S. Cl. CPC G06F 3/0484; G06F 3/0481; G06F 3/04883

(57) ABSTRACT

A system and application for extending the display of a computer to a mobile device is described. The system is configured to interface a mobile device with the computer, so as to enable a portion of the screen of the computer, such as toolbars, applets, menus, color palettes, and other application features to be displayed on the mobile device. Effectively, the system converts the display of the mobile device into a secondary display for the computer. Touch input is mapped to mouse input for the computer, enabling the user to manipulate applications running on the computer via touch input on the mobile device. The system employs Bluetooth, WiFi, and/or a cable to connect the mobile device to the computer. Preferred embodiments employ wireless technologies to facilitate the connection, and do not necessarily require an internet connection.

This application is a non-provisional application of provisional patent application No. 62/589,008, filed on Nov. 21, 2017, and priority is claimed thereto.

### FIELD OF THE PRESENT INVENTION

The present invention relates in general to graphical display solutions, and more specifically relates to a system by which a mobile device is interfaced with a computer, such as a laptop or PC, in order to augment the graphical display of the computer by porting a portion of the displayed elements to the screen of the mobile device.

### BACKGROUND OF THE PRESENT INVENTION

Conventionally, at least one display is connected to a computer, such as a PC or laptop. Often, users will connect multiple displays to a computer, especially in cases for drawing, animation, writing, etc. Professional power users generally prefer two, or even more displays to expedite and simplify use of the computer. For animation, digital art creation, video editing, and other tasks, users are known to use one display for palettes and tools, and to use the other display as the active workspace. The second screen is often used to display file attributes, panels, toolbars, and various other available selections.

Unfortunately, when using software on computers such as a laptop, which is conventionally equipped with a single display, the user loses the ability to have an easily accessible second screen to display these elements for quick use. If a user could employ his or her mobile device, such as a smartphone or tablet computer, as a small secondary screen, toolbars, palettes, and applets of the laptop could be displayed and manipulated via the screen of the mobile device, facilitating use of many programs while on-the-go, or at home.

Thus, there is a need for a system by which a user may interface his or her mobile device with a computer, such as a desktop computer or laptop computer, so as to facilitate the display and manipulation of elements of programs executed on the computer, such as, but not limited to, tool bars, color palettes, toggle switches, layer selectors, and other tools conventionally used with computer programs. Such a system is preferably configured to interface with the computer via a wireless connection, such as Bluetooth™ or WiFi, or may be connected directly via a USB cable. Additionally, such a system preferably facilitates manipulation of the content displayed on the mobile device via touch input, which is reflected on the computer by instantaneous changing of settings and/or artistic feature preferences.

For example, an individual is traveling, and requires use of the computer program Adobe™ PhotoShop™ to alter an image. Photoshop employs a wide variety of palettes, sidebars, and panels to control various actions. Conventionally, when using Photoshop on a two-screened desktop computer, one monitor is used to display the sidebars and panels, and the second monitor is used to display the digital image which is being manipulated. However, on a laptop, only one screen is often available. In such scenarios, the system of the present invention may be used to allow the user to connect his or her mobile device to the PhotoShop application running on the laptop computer, which would then exhibit and provide for the manipulation of panels and toolbars that would normally appears on the secondary desktop display of a desktop computer during image alteration. With the system of the present invention, the user may swipe the screen of the mobile device left and right to move from one panel to the other. The user may then manipulate/select desired attributes, and have the corresponding action occur on the laptop running the PhotoShop application.

Few instances are found in the prior art attempting to address this problem. For example, U.S. patent application Ser. No. 13/679,461, filed by Liang et al. on Nov. 16, 2012, is for a “Method and Apparatus for Enabling Interoperability of Touch Devices.” Liang et al. teaches a method that comprises establishing communication between “a master device and one or more slave devices” in which the master device and the one or more slave devices has a touch screen. This is unlike the present invention, which does not necessitate the computer to have a touch screen as taught by Liang et al. Additionally, the present invention differs from the teachings of Liang et al. in that the palates, in their entirety, are preferably depicted solely on the screen of the mobile device, thereby freeing space on the screen of the computer to facilitate the completion of creative work on the computer unencumbered by the clutter of tools and palates.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a system and application configured to enable a user to manipulate, via a mobile device, certain toolbars, applets, settings panels, color palettes, and other similar elements of a program running on a computer. The user may swipe on the screen of the mobile device to change which toolbar or settings panel is displayed on the screen. The panels are configured to be as fully actionable as the original native panels of the software running on the computer, complete with all subpanel elections.

The system of the present invention interfaces the mobile device to the computer via any existing radio technology, such as, but not limited to Bluetooth™ or Wi-Fi, or by using a direct physical connection, such as a USB cable. It is envisioned that the system of the present invention may be used with a myriad of computer forms and native applications, ranging from ATM machines and photo kiosks, to vending machines or laptop computers.

It should be understood that the system of the present invention is not an attempt to render an entire desktop screen, such as with some existing technologies. Instead, the system of the present invention functions as a direct analogue of existing menus, toolbars, palates, and settings panels within a main computer program. As such, the software powering the system of the present invention is preferably lightweight, requiring little computational resources, resulting in a highly responsive and quick user interface.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the system of the present invention via a mobile device actively interfaced with a computer, displaying a tool selector and toggle switches of an active graphical design program executed on the computer, shown on a computer screen.

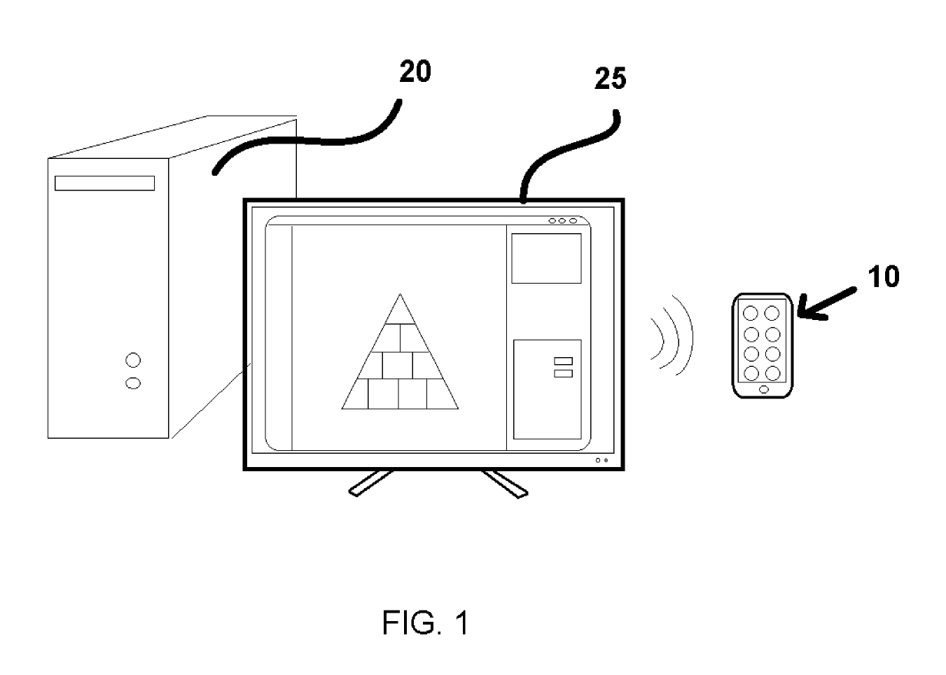

FIG. 2 details a flow chart depicting the process of set-up and use of the system and application of the present invention.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is system configured to interface a mobile device (10) with a computer (20), equipped with a monitor (25), which facilitates display of specific elements of computer programs/applications on a screen of the mobile device. The preferred embodiment of the present invention enables a user to view program elements, such as toolbars, palates, settings panels, and other similar applets on the screen of the mobile device (10). The present invention employs the onboard Bluetooth™ and/or WiFi radio(s) of the mobile device to interface with the computer wirelessly. Alternately, a USB cable may directly connect the mobile device (10) to the computer (20) to facilitate the connection.

While the system of the present invention is configured to display elements from the computer on the screen of the mobile device (10), rather than on the display screen of the computer, the present invention is not configured to display the entirety of the computer screen. As such, when a mobile device (10) is connected to a computer (20) via the system of the present invention, the entirety of the desktop screen is not rendered on the mobile device (10). Instead, only specific computer applications, when executed on the computer (20), may elicit a connection to the mobile device (10). Namely, the system of the present invention is intended best for use with creative programs, such as the Adobe™ Creative Suite™, Corel™ Draw, or other similar programs with menus, toolbars, and palates that may be moved (click and drag) away from the primary application window. Similarly, it should be understood that the system of the present invention may be used to render an image preview palette window of such creative programs on the mobile device (10).

The system of the present invention employs proprietary software to illicit the connection between the individual programs of the computer (20) and the screen and touch-based interface of the mobile device (10). As such, the software of the present invention is designed to automatically detect applicable and compatible running software on the computer (20), and port over pertinent or user-selected elements of the computer program, including, but not limited to menus, tool bars, color selection palette, tool selection dialogs, toggle switches, and other components of the running computer program. The user may then touch the screen of the mobile device (10) to manipulate these elements, and may swipe the screen of the mobile device (10) to change which element is displayed on the screen of the mobile device.

Ideally, the system of the present invention is configured to display a single panel (containing said elements) on the screen of the mobile device at any given time. It is envisioned that unlimited panels may be accessible via the screen of the mobile device (10), however the user must swipe between each panel to change which elements are displayed on the screen.

The software facilitating the system of the present invention is preferably kept lightweight by eliminating the need to directly port any portion of the screen of the computer to the mobile device. Instead, the controlling elements of each panel are displayed at a different size, orientation, and format suitable for viewing and manipulation from the touchscreen of the mobile device (10). One or more ‘plug-ins’ or applets may be employed to facilitate the porting of settings, toolbars, and palates to the mobile device (10) in a lightweight manner. A plug-in is required for the use of the system of the present invention with specific programs/software companies, in accordance with their respective operating system in use. It is envisioned that the mobile device application of the present invention be compatible with a wide variety of programs via independent plug-ins crafted for each individual program pertinent for use with the system of the present invention.

The system of the present invention ensures that the mobile device application remains lightweight, taking little RAM and processing power of the mobile device by only providing details regarding the present state of the palettes active on the mobile device. The application of the present invention on the mobile device is equipped with a set of custom templates with conditions which are rendered and populated as necessary (when requested by user). As such, via the modular plug-in-based system of the present invention, interacting with the mobile device application of the present invention, there are no limits to the types of programs compatible with the system. Customization of the content displayed on the mobile device during use is required per program for differentiation, as well as with respect to the function of the interfaced program. It is envisioned that software companies will participate in the construction of the requisite plug-ins to make their programs accessible and capable of manipulation via the touch screen of a mobile device.

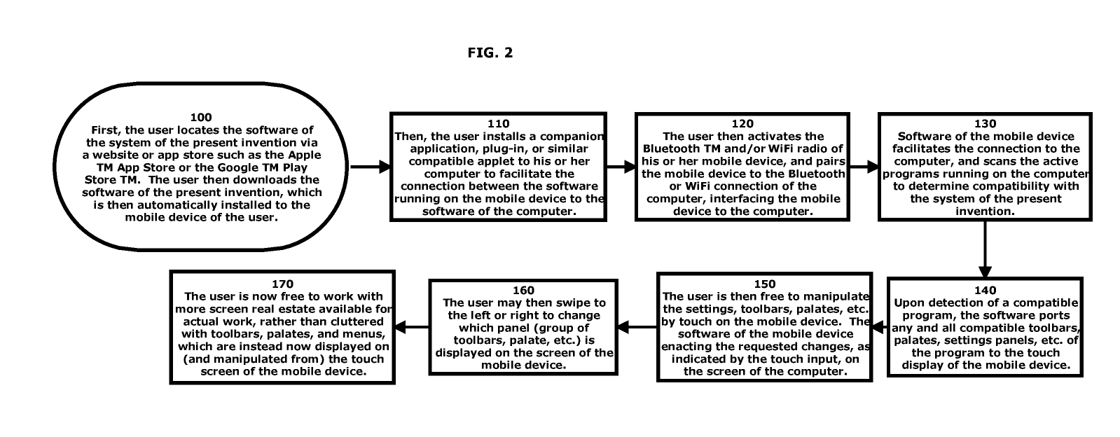

The system of the present invention is preferably easy to install to both the computer (20) and to the mobile device (10). The process of use and installation of the system of the present invention, as shown in FIG. 2, is preferably as follows:

1. First, the user locates the software of the system of the present invention via a website or app store such as the Apple™ App Store or the Google™ Play Store™. The user then downloads the software of the present invention, which is then automatically installed to the mobile device of the user. (100)

2. Then, the user installs a companion application, plug-in, or similar compatible applet to his or her computer to facilitate the connection between the software running on the mobile device to the software of the computer. (110) In some cases, this may be preinstalled on the computer, or may be bundled as a part of specific programs compatible with the system of the present invention. If the user presently has no compatible programs installed on his or her computer, the user first must install a compatible program such as Adobe™ PhotoShop™. In instances of use of the present invention with a computer or computerized system (such as a vending machine) that is not owned by the user, this step may be omitted.

3. The user then activates the Bluetooth™ and/or WiFi radio of his or her mobile device, and pairs the mobile device to the Bluetooth or WiFi connection of the computer, interfacing the mobile device to the computer. (120) Note that the Bluetooth and/or WiFi radio of the computer must also be activated to enable an active connection to the mobile device. Alternately, a USB cable may be used to facilitate the connection.

4. Software of the mobile device facilitates the connection to the computer, and scans the active programs running on the computer to determine compatibility with the system of the present invention. (130)

5. Upon detection of a compatible program, the software ports any and all compatible toolbars, palates, settings panels, etc. of the program to the touch display of the mobile device. (140)

6. The user is then free to manipulate the settings, toolbars, palates, etc. by touch on the mobile device. The software of the mobile device enacting the requested changes, as indicated by the touch input, on the screen of the computer. (150)

7. The user may then swipe to the left or right to change which panel (group of toolbars, palate, etc.) is displayed on the screen of the mobile device. (160)

8. The user is now free to work with more screen real estate available for actual work, rather than cluttered with toolbars, palates, and menus, which are instead now displayed on (and manipulated from) the touch screen of the mobile device. (170)

Alternate embodiments of the present invention may include adaptation of the present invention to function as a limited second monitor display for a portion of the screen (25) of the computer (20) itself. Such instantiations are configured to facilitate palette mirroring if necessary (for example to display a marquee of a zoomed region). If possible a lightweight payload could be achieved by concentrating on the portrayal of the palettes and not necessarily the entire display. Embodiments of the present invention could also incorporate mouse movement/control if it is advantageous to the user experience. Displaying the entire program could be an option but this would be less than optimal. Impact on the user experience and interface needs would control the implementation of full screen mirroring in such embodiments of the present invention.

Additionally, in certain instances, the plug-in applications to be executed on the computer (20) may need to be installed separately from the primary program's installation to the computer (20). As such, the plug-in applications of the computer (20) may be held within non-transitory memory to optimize functionality. Depending on the application to interface with the mobile device (10), additional software may be required to be installed by the user. The mobile device application of the present invention is envisioned to be upgraded over time, as operating systems and augmented software mature and develop. Presently there are no special requirements for use of the present invention, however it is recommended that Android™ 6 and/or iOS™ 10 as the minimum recommended operating systems for use with the present invention. Devices intended for use with the system of the present invention are preferably equipped with the following minimum specifications:

Android: Qualcomm Snapdragon 805 processor

iOS: A8 processor with 64-bit architecture

It should be noted that some embodiments of the present invention employ a computer readable medium which is non-transitory.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method of rendering program-specific data from computer software of a computer to a mobile device comprising:
interfacing the mobile device with the computer;
eliciting a connection between an individual program of the computer software of the computer and a touch-based screen interface of the mobile device via proprietary software;
the proprietary software automatically detecting applicable and compatible running software of the computer; and
the proprietary software porting over pertinent elements of the computer program to the touch-based screen interface of the mobile device.

2. The method of claim 1, further comprising:
manipulating the touch-based screen interface to toggle between pertinent elements of the computer program to alter the display of the touch-based screen interface.

3. The method of claim 1, wherein pertinent elements of the computer program include data selected from the group: image preview palette window, tool selection dialogs, toggle switches, color selection palette, tool bars, menus, and image manipulation tools.

4. The method of claim 1, wherein pertinent elements are depicted on a single panel on the screen of the mobile device, the single panel containing graphical depictions of the pertinent elements.

5. The method of claim 1, further comprising: the proprietary software scaling the pertinent elements in accordance with the specific screen size of the mobile device.

6. The method of claim 1, wherein the proprietary software employs at least one plug-in to facilitate the porting of the pertinent elements to the touch-based screen interface of the mobile device.

7. The method of claim 2, wherein pertinent elements of the computer program include data selected from the group: image preview palette window, tool selection dialogs, toggle switches, color selection palette, tool bars, menus, and image manipulation tools.

8. The method of claim 2, wherein pertinent elements are depicted on a single panel on the screen of the mobile device, the single panel containing graphical depictions of the pertinent elements.

9. The method of claim 2, wherein pertinent elements are depicted on a single panel on the screen of the mobile device, the single panel containing graphical depictions of the pertinent elements.

10. The method of claim 3, wherein the proprietary software employs at least one plug-in to facilitate the porting of the pertinent elements to the touch-based screen interface of the mobile device.

11. The method of claim 3, further comprising: the proprietary software scaling the pertinent elements in accordance with the specific screen size of the mobile device.
